(19) United States
(12) Patent Application Publication
(10) Pub. No.: US 2019/0386605 A1
(43) Pub. Date: Dec. 19, 2019

(54) MODULAR, PORTABLE AND TRANSPORTABLE THERMO-ELECTRIC SYSTEM

(71) Applicant: Frank C Pao, Boston, MA (US)

(72) Inventor: Frank C Pao, Boston, MA (US)

(21) Appl. No.: 16/391,154

(22) Filed: Apr. 22, 2019

Related U.S. Application Data
(63) Continuation-in-part of application No. 15/217,784, filed on Jul. 22, 2016, now abandoned.

(51) Int. Cl. H02S 20/25; F24S 25/10; F24S 25/61; F24S 25/63; F24S 20/69

(52) U.S. Cl. CPC H02S 20/25; F24S 25/10; F24S 2020/17; F24S 25/63; F24S 20/69; F24S 25/61

(57) ABSTRACT

A modular integrated thermal-electric roofing system is disclosed. The system may include a thermal collector system configured with a photovoltaic system. The thermal collector system may include a liquid flowing through thermal tubing that may be heated by the sun. A pump and thermal control system may extract thermal energy from the liquid. A series of photovoltaic tiles may be configured on top of the thermal tubing to collect solar energy and convert it into electricity, and to aid in the heating of the thermal tubing. On doing so, the thermal tubing may cool the photovoltaic tiles. The system may be modular for easy installation. The system may also be mounted onto a support structure and may be portable and/or transportable.

### REFERENCE TO RELATED APPLICATIONS

This application is a Continuation-in-Part of U.S. patent application Ser. No. 15/217,784 filed on Jul. 22, 2016, the contents of which are fully incorporated herein by reference for any purpose.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to roofing systems, including modular, portable and transportable integrated thermal-electric roofing systems.

### BACKGROUND OF THE INVENTION

Solar energy has received increasing attention as an alternative renewable, non-polluting energy source, and photovoltaic installations on commercial and residential roofs are becoming increasingly popular. One important way to reduce global warming would be to use alternative or renewable energy, such as, solar energy which is environment friendly and cost effective in the long run than the conventional methods. A properly sized and easily installed solar thermal energy collection system with a removable modular structure can be a practical alternative for acquiring some of the energy needs.

Building integrated technology is most commonly applied as new roofing materials that replace an existing roof, either as a shingle comprised of thin film solar material, or thin film material rolled onto a metal roof and affixed with an adhesive. The photovoltaic roof that includes panels having a galvanized steel supporting layer with side supporting flanges interconnected to form a roof assembly (a typical standing seam roof). The mid portion of each panel has a photovoltaic surface made formed of amorphous semi-conductor material which is laminated onto the galvanized steel supporting layer. Moreover, such a system is difficult to install and affect the integrity of the roof of the building.

Another existing prior art discloses as roof installations consisting of an array of interfitting members e.g. tiles, strips, slats or the like which interfit to form a roof covering and a set of heat pipes which run parallel to the plane of the roof. Heat is extracted from the heat pipes and used directly or indirectly, e.g. via a heat pump apparatus. The solar heating system for mounting under a roof that includes a panel formed of a sheet material and at least one run of tubing held beneath the panel by a plurality of tubing fasteners. The panel assembly facilitates transfer of the trapped heat from the roof and surrounding air into the fluid circulating through the tubing. However, such a system is difficult to install at the roof of the building. Moreover, such a system does not have a removable modular structure.

The sun's energy can be collected in a variety of different ways. One is converting sun's energy into thermal energy to heat thing. The roof installations consisting of an array of interfitting members e.g. tiles, strips, slats or the like which interfit to form a roof covering and a set of heat pipes which run parallel to the plane of the roof. Heat is abstracted from the heat pipes and used directly or indirectly, e.g. via a heat pump apparatus. The solar heating system for mounting under a roof that includes a panel formed of a sheet material and at least one run of tubing held beneath the panel by a plurality of tubing fasteners. The panel assembly facilitates transfer of the trapped heat from the roof and surrounding air into the fluid circulating through the tubing. Such arrangements will not generate sufficient energy to be self-sustaining due to less conversion rate and these are not aesthetically pleasing.

Accordingly, there is a need for a modular building integrated thermal system that provides easy installation with a removable modular structure. Such a needed system would provide a modular thermal unit for an easy installation on the roof of the building. Such a needed system would provide a pump and thermal control system. Further, such a device would effectively utilize the sun's energy, would be self-sustaining, aesthetically pleasing, and economical. The present invention accomplishes these objectives.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a layout of a building integrated modular thermal unit in accordance with a preferred embodiment of the present invention;

FIG. 2 illustrates a block diagram of the pump and thermal control system in accordance with the present invention;

FIG. 3 illustrates building integrated modular thermal system installed on a house in accordance with a preferred embodiment of the present invention;

FIGS. 4A and 4B illustrates shows a schematic view of the metal battens and a heat pipe holder utilized in accordance with a preferred embodiment of the present invention.

FIG. 5 is a flow chart for a method of mounting a modular building integrated thermal system in accordance with a preferred embodiment of the present invention;

FIG. 6 illustrates a schematic diagram of a modular building integrated thermal system in accordance with a preferred embodiment of the present invention;

FIGS. 7A and 7B illustrate a parallel thermal tubing layout of a modular building integrated thermal system in accordance with a preferred embodiment of the present invention.

FIG. 8 shows aspects of thermal collector modules according to exemplary embodiments hereof;

FIG. 9 shows aspects of solar roofing modules according to exemplary embodiments hereof;

FIG. 10 shows aspects of integrated thermal-electric modules according to exemplary embodiments hereof;

FIG. 11 shows aspects of a portable and/or transportable integrated thermal-electric system according to exemplary embodiments hereof; and

FIGS. 12-13 show aspects of a standalone portable and/or transportable integrated thermal-electric system according to exemplary embodiments hereof.

### DETAILED DESCRIPTION OF THE EXEMPLARY EMBODIMENTS

A system according to exemplary embodiments of the current invention is described with reference to the figures.

In general, and in some exemplary embodiments hereof, the system may include thermal energy collection systems that may be combined with solar energy collection systems. In some of the exemplary embodiments hereof, the systems may be modular, portable and/or transportable.

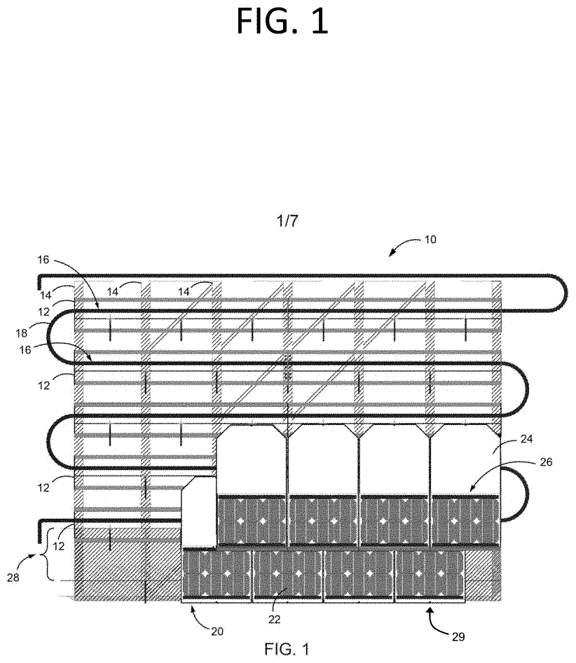

FIG. 1 illustrates an exemplary layout of a modular integrated thermal-electric roofing system 10. The modular thermal-electric unit 10 may include one or more metal battens 12 mounted horizontally onto a plurality of wooden battens 14 that may be mounted vertically across a roof (not shown). That is, the wooden battens 14 may be configured vertically and side-by-side at a predetermined spacing across the roof from the left to the right, and the metal battens 12 may extend across the wooden battens horizontally from the left to the right across the roof. This may form a matrix of wooden battens 14 and metal battens 12. While FIG. 1 shows seven wooden battens 14 and five metal battens 12, any number of wooden and/or metal battens 14, 12 may be used.

The one or more metal battens 12 may each include a longitudinal channel 16 that may extend in a longitudinal direction along the length of the metal batten 12. A thermal collector system 15 may include a thermal tubing 18 structure that may extend along the longitudinal channel 16, the thermal tubing 18 structure being configured to circulate liquid for absorbing or otherwise collecting thermal energy. The system 10 may further include a plurality of solar electric roof tiles 20 mounted on the plurality of metal battens 12. The plurality of solar roof tiles 20 may comprise a building integrated photovoltaic roof tile having a solar module 22 that may be secured (e.g., glued) to a standard roof slate or tile 24 (e.g., a fiber cement tile, an Eternit® tile or other types of roofing tiles). Each of the plurality of solar electric roof tiles 20 may be mounted on the plurality of metal battens 12, and each of the plurality of solar electric roof tiles 20 may be connected in series to form a string 26 of tiles 20 in series. For the purposes of this specification, a set of one or more solar electric roof tiles 20 (e.g., two or more solar roof tiles 20 configured in series into a string 26) may be referred to as a solar roof tile system 27. It is understood that the solar roof tiles 20 may also be configured together in parallel and/or in any combination of series and/or parallel.

The metal battens 12 may be designed to hold roof tiles thereon. As roof dimensions may vary according to roof design, a starter section 28 may be provided that may adjust the string 26 of the plurality of solar electric roof tiles 20 accordingly.

Each of the plurality of solar roof tiles 20 may be mounted on the plurality of metal battens 12 using a storm anchor hook 29 (or other type of attachment mechanism) which may be hammered into a hole (not shown) provided in each of the plurality of metal battens 12. The storm anchor hook 29 is designed in such a way that the plurality of solar roof tiles 20 may partially overlap one another as shown. A plurality of holes (not shown) may be drilled in advance on each of the plurality of metal battens 12 according to specified positions which saves time and simplifies the installation procedures. The specified positions may be based on the size of the plurality of solar electric roof tiles 20.

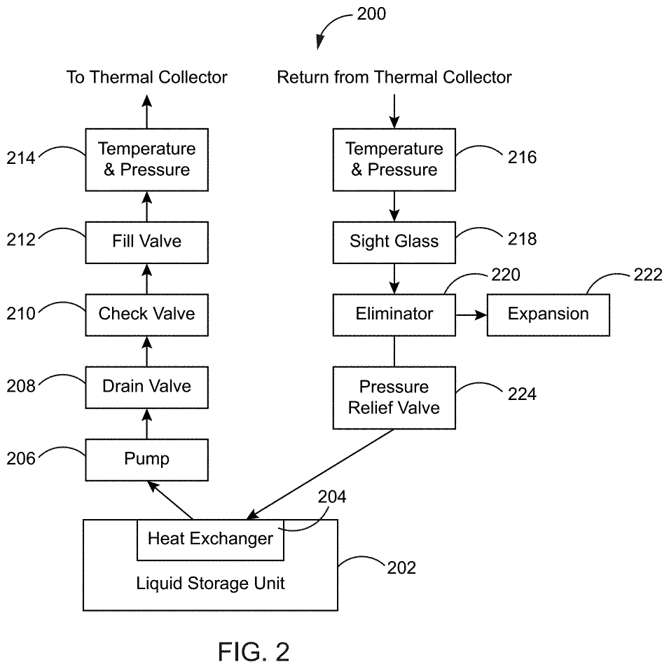

FIG. 2 illustrates a block diagram of the pump and thermal control system 200 in accordance with the present invention. A thermal control system 200 may be connected to an input section and an output section of the thermal tubing 18 to output to and receive from the liquid flowing through the tubing 18. In one exemplary embodiment hereof, the thermal control system 200 may include a liquid storage unit 202 for storing the liquid therein. A pump 206 may receive the liquid from the liquid storage unit 202 and may circulate the liquid to the thermal tubing structure 18. A heat exchanger 204 may be connected to the liquid storage unit 202 and to the pump 206 and may be configured to exchange (extract) heat from the liquid. The thermal control system 200 may also include a drain valve 208 that transfers the liquid received from the pump 206 to the thermal tubing structure 18 and drains excess liquid in a controlled manner. A check valve 210 may also be included that regulates the flow of air, as well as a fill valve 212 that receives the liquid from the drain valve 208 and regulates the filling of the liquid into the thermal tubing structure 18 through the input section.

A forward gauge assembly 214 having a first temperature gauge and a first pressure gauge may check the temperature and pressure of the liquid flowing from the fill valve 212 to the thermal tubing 18. A backward gauge assembly 216 having a second temperature gauge and a second pressure gauge may check the temperature and pressure of the liquid flowing from the output section of the thermal tubing structure 18 back to the thermal control system 200. A flow sight glass 218 may regulate the flow of liquid from the thermal tubing structure 18, and an air eliminator 220 may release air from the thermal tubing structure 18. An expansion tank 222 may be provided to collect and expand the air coming from the air eliminator 220. The expansion tank 222 may be insulated using an insulator such as Styrofoam (not shown). A pressure relief valve 224 may safety release excel pressure from the thermal tubing structure 18 and an energy/liquid storage tank 202 may store the heated liquid received from the output section of the thermal tubing structure 18.

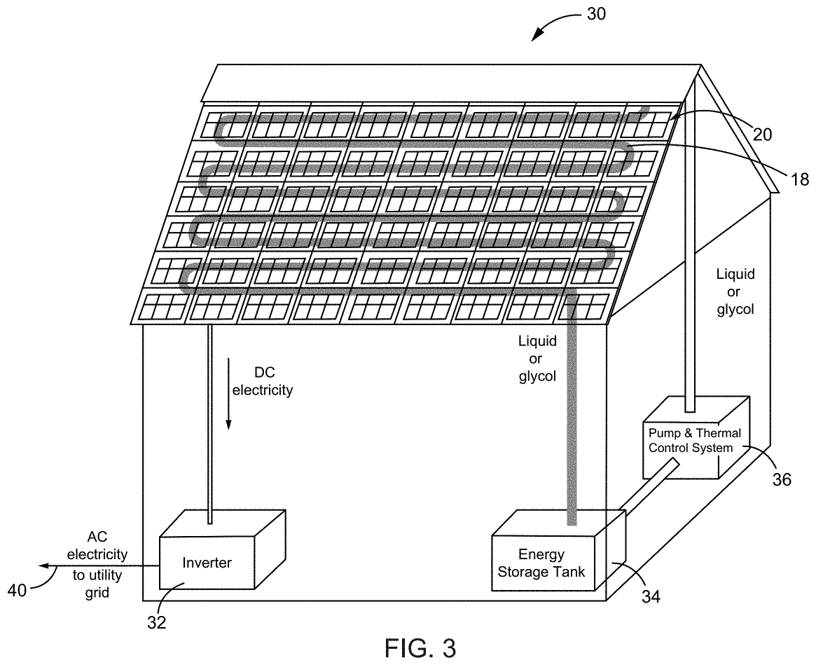

FIG. 3 illustrates a building integrated modular thermal-electric system installed on a house 30. In the present invention, the integrated thermal and electric systems work in conjunction as well as compensate with each other. As shown, the present invention further comprises an inverter 32 connected to each string 26, a pump and thermal control system 36 (that my correspond to the thermal control system 200 of FIG. 2) is connected between an energy storage tank 34 from the thermal tubing 18. The thermal tubing 18 in the present invention may be PEX, brass, copper, aluminum and/or any other type of tubing, and liquid running through the thermal tubing 18 may be water, glycol and/or other types of liquids. Each string 26 can be connected to the inverter 32 or numerous strings can be connected in parallel to the inverter 32 in another embodiment of the invention.

As solar energy hits one or more surfaces of the plurality of solar roof tiles 20, the plurality of solar roof tiles 20 may generate DC electricity. The inverter 32 may convert the DC electricity to AC electricity and provide the electricity to a utility grid 40, to a battery or elsewhere. In addition, the solar roof tiles 20 may also be heated from the sunlight that may strike the tiles 20. The plurality of metal battens 12, being in direct physical contact with the heated tiles 20, may act as a heat sink and draw heat from the heated solar roof tiles 20 (via conduction and/or convection) into the battens 12. The metal battens 12 may then transfer the heat to the thermal tubing and to the liquid running through the thermal tubing 18 (via conduction and/or convection) throughout the roof (not shown). In other embodiments, the thermal tubing 18 may also be in direct physical contact with the solar roof tiles 20 and draw heat directly from the heated solar roof tiles 20 into the thermal tubing 18 and the liquid therein. The heated liquid may flow down to the pump and thermal control system 200 and the thermal energy within the heated liquid may then be transferred to the heat exchanger 34 and used to heat up the domestic water supply thus providing domestic hot water.

In addition, because the thermal energy is extracted from the heated solar roof tiles 20 (via the metal battens 20 and/or the thermal tubing 18 and/or the liquid within the tubing 18) and transferred to the heat exchanger 34, the solar roof tiles 20 may be cooled and may thereby operate at higher efficiency in converting the solar energy to DC electricity. Moreover, as the modular thermal unit 10 captures more solar energy, the modular thermal unit 10 has much high energy conversion rate thereby reducing the need for any HVAC power consumption. In the preferred embodiment, the thermal collector system 15 and the solar roof tiles 20 may operate simultaneously to generate domestic hot water and electricity respectively. However, it is also understood that the thermal collector system 15 and the solar roof tiles 20 may also operate independently of each other, in conjunction, and/or in any combination thereof.

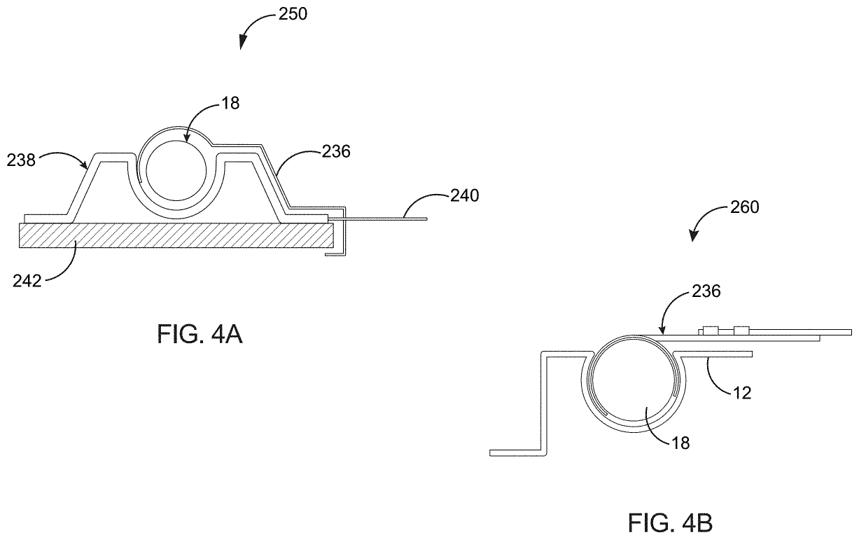

FIGS. 4A and 4B show cross-sectional views of the metal battens 12 and a heat pipe holder 236 according to exemplary embodiments hereof. Each of the plurality of metal battens 12 may include a longitudinal channel 16 that extends in the longitudinal direction on the opposing sides thereof. The plurality of metal battens 12 may be mounted (e.g., horizontally) onto the plurality of wooden battens 14 that may be mounted (e.g., vertically) across a roof (not shown). Each horizontal section of the thermal tubing 18 may be configured with and extend along the longitudinal channel 16 in the longitudinal direction of an associated metal batten 12. Thus, the metal battens 12 may secure and hold both the thermal tubing 18 and the plurality of solar electric roof tiles 20.

One or more heat pipes 240 may be positioned in the roof space extending substantially from the metal battens 12 and/or the thermal tubing 18 (e.g., from the battens 12 and/or the thermal tubing 18 to the eaves of the roof). The spacing between the each of the plurality of metal battens 12 can be varied subject to the size of the plurality of solar electric roof tiles 20 and the required thermal specification. As the plurality of metal battens 12 are more tightly spaced, more thermal tubing 18 can be installed to achieve high thermo energy conversion efficiency. The one or more heat pipes 240 may be mounted to the metal battens 12 and/or the thermal tubing 18 utilizing a heat pipe holder 236. In one exemplary embodiment hereof, the heat pipe holder 236 may include a circular bracket that may be configured with the thermal tubing 18. A flat metal piece may be attached (e.g., welded) onto the circular bracket with at least one notch adaptable to hold the at least one heat pipe 240. It is understood that the one or more heat pipes 240 may be mounted or otherwise secured using other attachment mechanisms.

In another exemplary embodiment hereof, the one or more heat pipes 240 may be mounted to the metal battens 12 and/or the thermal tubing 18 utilizing a heat pipe holder that may be in turn mounted to the plurality of wooden battens 14. The heat pipe holder 236 may include a circular bracket that is configured (snapped onto) with the thermal tubing 18. A notch may be configured on at least one purlin 238 to hold the at least one heat pipe 240. A fiberglass insulation 242 may be installed between the purlins 238 however this may not be required.

In one aspect of the present invention, in order to capture more thermal energy from the sun, the heat pipe 240 may be applied onto the thermal system 15. The metal batten 12 and the purlins 238 may hold the thermal tubing 18 by using one or more heat pipe holders 236 to mount onto the thermal tubing 18. The metals batten 12 may include a circular bracket that may be attached (e.g., snapped) onto the thermal tubing 18. A flat metal piece may be attached (e.g., welded) onto the circular bracket with one or more notches that may be used to hold the heat pipe 240. Moreover, in the purlin 238 the heat pipe holder 236 would be locked onto the wooden or fiber glass and the circular side of the holder may be snapped directly onto the thermal tubing 18. A notch may be formed to hold the heat pipe 240.

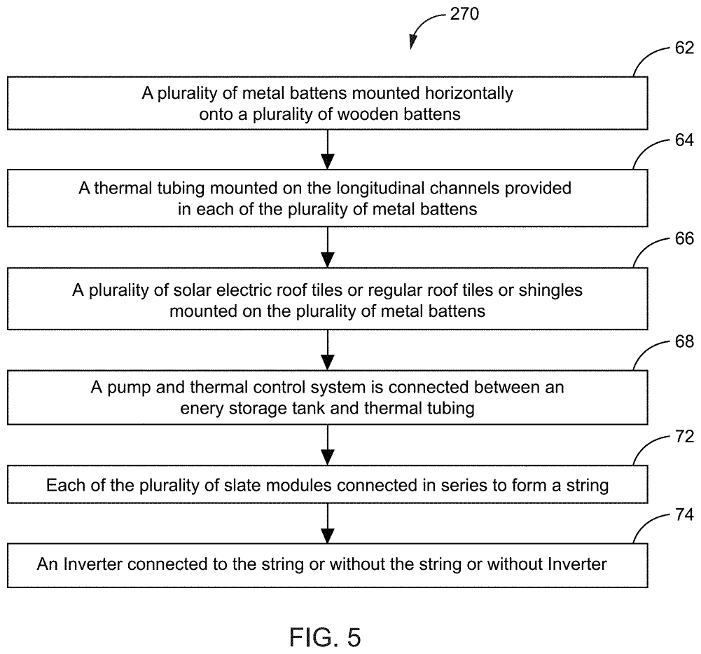

FIG. 5 is a flow chart for a method of mounting a modular building integrated thermal-electric system 10. As shown in step 62, a plurality of metal battens 12 is mounted horizontally onto a plurality of wooden battens 14. A thermal tubing system 18 is mounted on the longitudinal channels 16 provided in each of the plurality of metal battens 12 as shown in step 64. A plurality of solar electric roof tiles 20 is mounted on the plurality of metal battens 12 using a storm anchor hook (or other attachment mechanisms) as shown in step 66. It is understood that other types of roof tiles or shingles (e.g., non-photovoltaic roof tiles) may also be mounted if photovoltaic roof tiles are not desired. Each of the plurality of slate modules (the photovoltaic roof tiles) may be connected in series to form a string as shown in step 72. As shown in step 74, an inverter may be connected to each of the strings. As shown in step 68, a pump and thermal control module 200 may be connected between an energy storage tank and the thermal tubing 18.

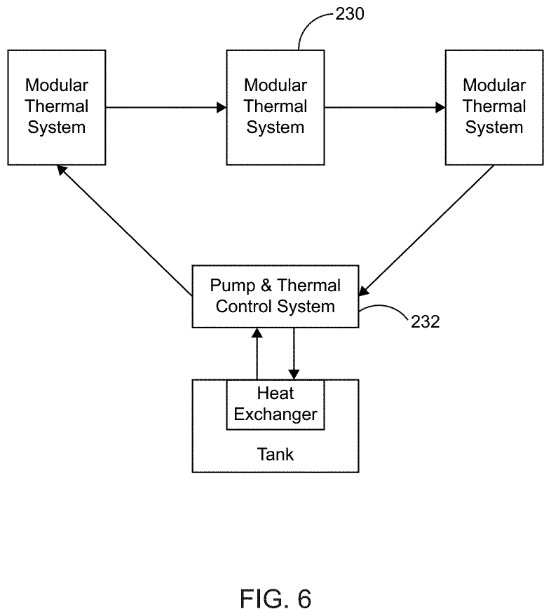

FIG. 6 illustrates a schematic diagram of a modular building integrated thermal system. One or more modules 230 of the modular thermal collector system 15 may be lifted by a crane (or otherwise moved and properly positioned) and each module 230 may be mounted to the battens on the roof of the building. Once the modules 230 of the modular thermal system are configured with the roof, the modules 230 may be configured together to form the overall modular thermal collector system 15 and a pump and thermal control system 232 may be connected between the tank and the overall modular thermal collector system 15. In this way, the modular building integrated thermal system provides an easy installation with a removable modular structure. This will be described in further detail in other sections.

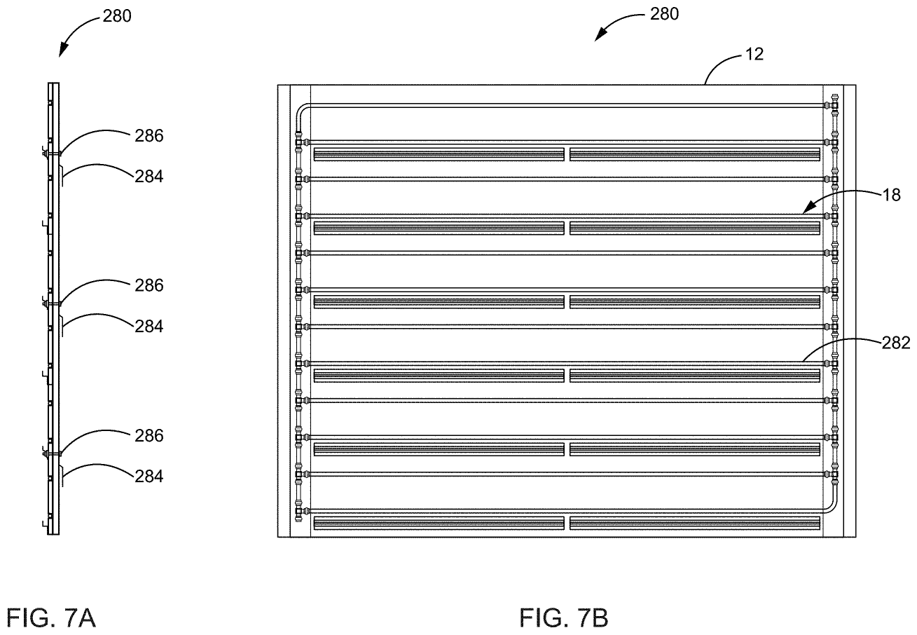

FIGS. 7A and 7B illustrate a parallel thermal tubing layout 280 of a modular building integrated thermal system in accordance with a preferred embodiment of the present invention. In this embodiment, the thermal tubing structure 18 includes thermal tubes 282 that are arranged parallel to the length of the system to minimize the heat transfer surface requirements thereby providing good temperature balance and minimal thermal stresses that may develop in the tubes 282. The parallel thermal tubes 282 may be installed to the plurality of metal battens 12 utilizing at least one securing means 284.

In one exemplary embodiment hereof, the at least one securing means 284 may include a hybrid cleat. The hybrid cleats 284 may be attached to the plurality of metal battens 12 using screws 286 inserted through drill holes on the hybrid cleat 284 and metal battens 12. In one preferred implementation, the hybrid cleat 284 may be positioned about six inches from vertical edges of a 1-inch thick solid foam board. Each solid foam board may include six hybrid cleats 284 (or any other number of cleats 284 as required). The thermal tubes 282 may preferably include flexible, cross-linked polyethylene tubing, (e.g. Wirsbo AquaPEX™ type), other types of tubing and any combination thereof.

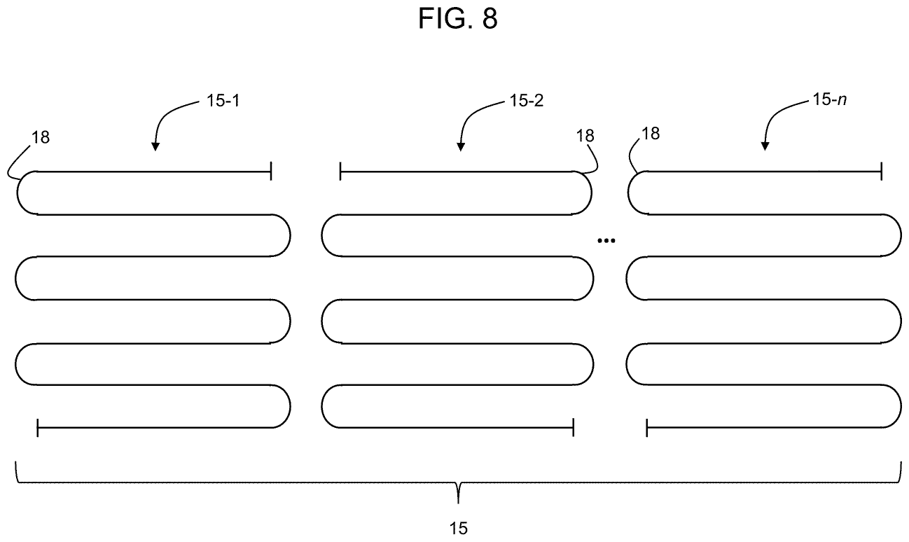

In one exemplary embodiment hereof as shown in FIGS. 6 and 8, the integrated thermal-electric roofing system 10 may be modular. In one exemplary embodiment, the thermal collector system 15 and the solar roof tile system 27 may be modularized, individually and/or in any combination.

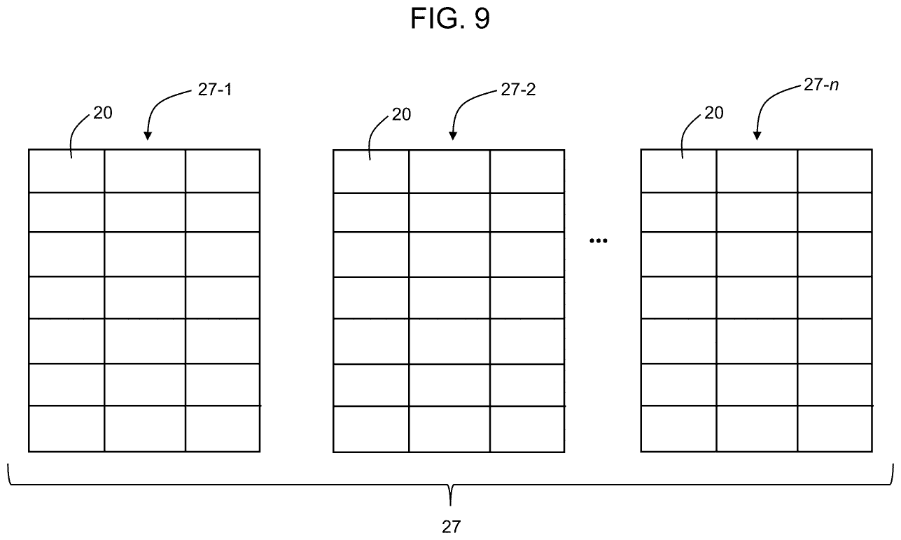

As shown in FIG. 8, the thermal collector system 15 comprising of thermal tubing 18 may be divided into thermal collector modules 15-1, 15-2, . . . 15-n, that when combined may form the overall thermal collector system 15. In addition, as shown in FIG. 9, the solar roof tile system 27 may be divided into solar roofing modules 27-1, 27-2, . . . 27-n, that when combined may form the overall solar roofing system 27. Note that each solar roofing module 27-n may include one or more solar roof tiles 20.

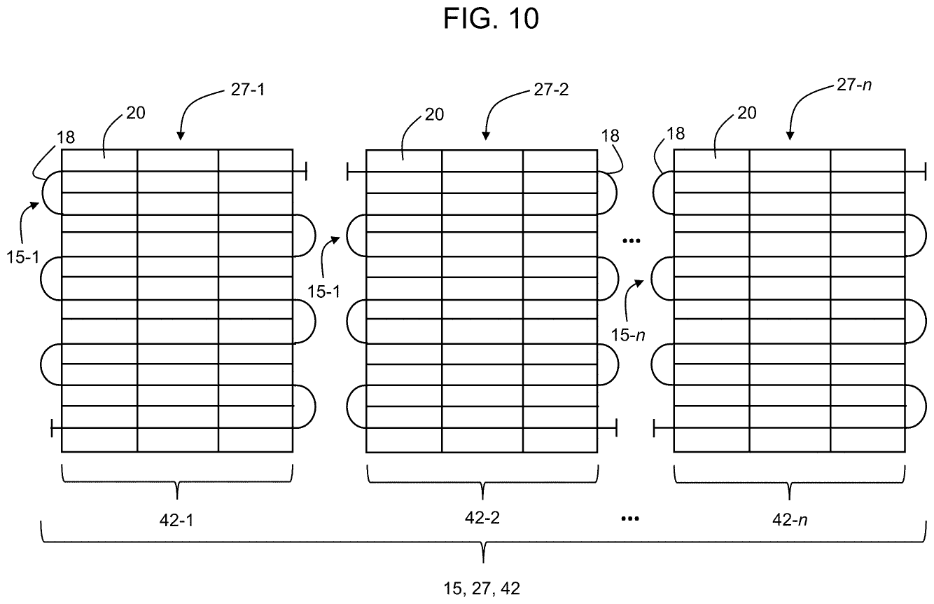

In one exemplary embodiment hereof as shown in FIG. 10, a thermal collector system module 15-1 may be configured with an associated solar roofing system module 27-1 to form an integrated thermal-electric module 42-1. Expanding on this concept, a thermal collector system module 15-2 may be configured with an associated solar roofing system module 27-2 to form an integrated thermal-electric module 42-2, and a thermal collector system module 15-n may be configured with an associated solar roofing system module 27-n to form an integrated thermal-electric module 42-n. Then, one or more integrated thermal-electric module 42-n may be combined to form an overall integrated thermal-electric system 42.

In use, the wooden battens 14 and the associated metal battens 12 may be mounted or otherwise configured with the roof of a building as described in other sections of this specification. The battens 12, 14 may be installed prior to the installation of the integrated thermal-electric modules 42-n. Once the battens 12, 14 may be installed, the integrated thermal-electric modules 42-n may be installed one by one, or in any combinations. That is, a first the integrated thermal-electric module 42-1 may be installed onto the metal battens 12, and then a second integrated thermal-electric module 42-2 may be installed onto the metal battens 12. Or, a first and a second thermal electric-electric module 42-1, 42-2 respectively may be installed together in combination. It may be preferable that the integrated thermal-electric modules 42-1 and 42-2 may be installed in a configuration (e.g., side by side) such that the modules 42-1, 42-2 may be electrically connected and configured together to form an overall integrated thermal-electric system 42. In this way, because the individual modules 42-n may be easier to transport, lift, position and otherwise install, the modularity of the system 10 may enable easier and less costly installation of the system 10.

In one example of an exemplary embodiment hereof, the modules 42-1, 42-2 may be configured together by configuring the output of the thermal tubing 18 from the first module 42-1 (and its thermal collector module 15-1) to the input of the thermal tubing 18 of the second module 42-2 (and its thermal collector module 15-2) (or vice versa) such that the combined tubing 18 of the combined modules 42-1, 42-2 may be continuous and fluid as required. This may form an overall thermal collector system 15. In another example of an exemplary embodiment hereof, the modules 42-1, 42-2 may be configured together by configuring the solar roofing module 27-1 of the first module 42-1 with the solar roofing module 27-2 of the second module 42-2 such that the combined solar roofing modules 27 may be configured in series as required. In this way, the modules 42-1, 42-2 may be combined to form an overall thermal collector system 15, an overall solar roofing system 27 and an overall integrated thermal-electric system 42.

Once configured, the overall thermal collector system 15 may be configured with the pump and thermal control system 200, the heat exchanger and the liquid storage tank 202, and the overall solar roofing system 27 may be configured with the inverter 32 to provide the overall system 10.

It is understood that any number of modules 42-n may be combined or otherwise configured together to form an overall thermal collector system 15, an overall solar roofing system 27 and/or an overall integrated thermal-electric system 42.

It is also understood that any number of thermal collector modules 15-1, 15-2, . . . 15-n, may be combined to form any number of overall thermal collector systems 15, and that any number of solar roofing modules 27-1, 27-2, . . . 27-n, may be combined may form any number of overall solar roofing systems 27. It is also understood that the thermal collector modules 15-1, 15-2, . . . 15-n, need not necessarily be combined with the solar roofing modules 20-1, 20-2, . . . 20-n, but instead may be combined to form any number of individual overall thermal collector systems 15. It is also understood that the solar roofing modules 27-1, 27-2, . . . 27-n, need not be combined with the thermal collector modules 15-1, 15-2, . . . 15-n, but instead may combined to form any number of individual overall solar roofing systems 27. When the thermal collector modules 15-1, 15-2, . . . 15-n, and the solar roofing modules 27-1, 27-2, . . . 27-n, may be combined to form one or more overall integrated thermal-electric systems 42, the number of thermal collector modules 15-1, 15-2, . . . 15-n, need not necessarily match the number of solar roofing modules 27-1, 27-2, . . . 27-n, however it may be preferable that they do.

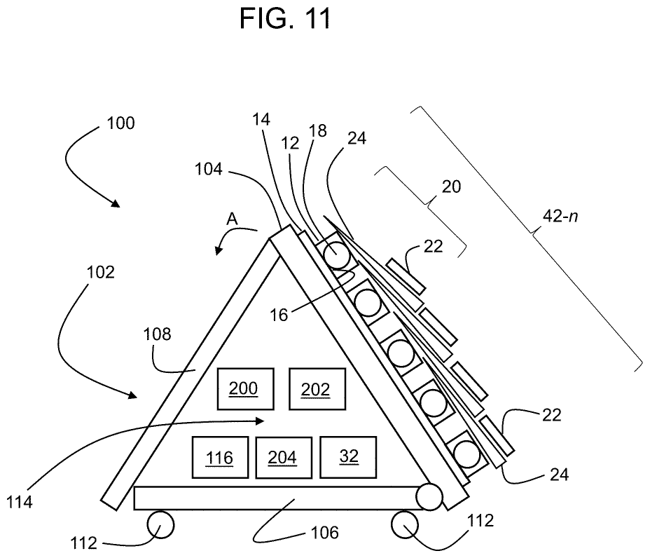

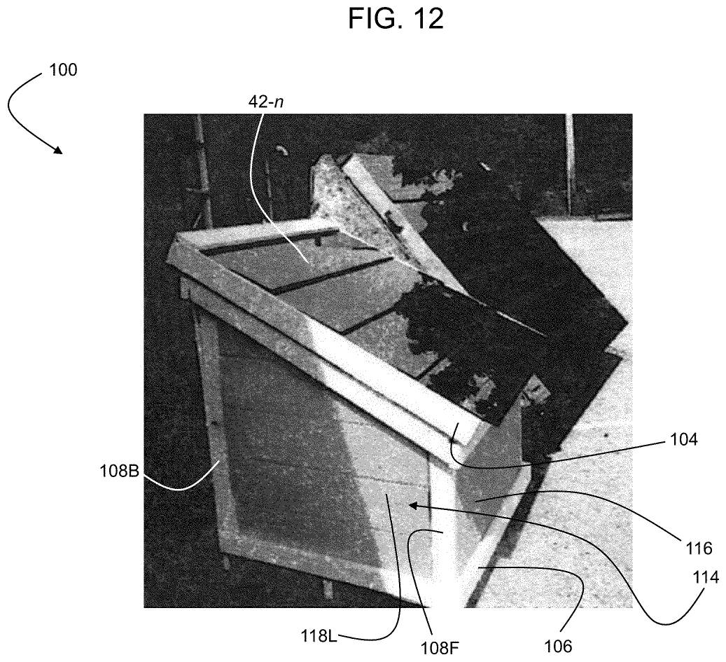

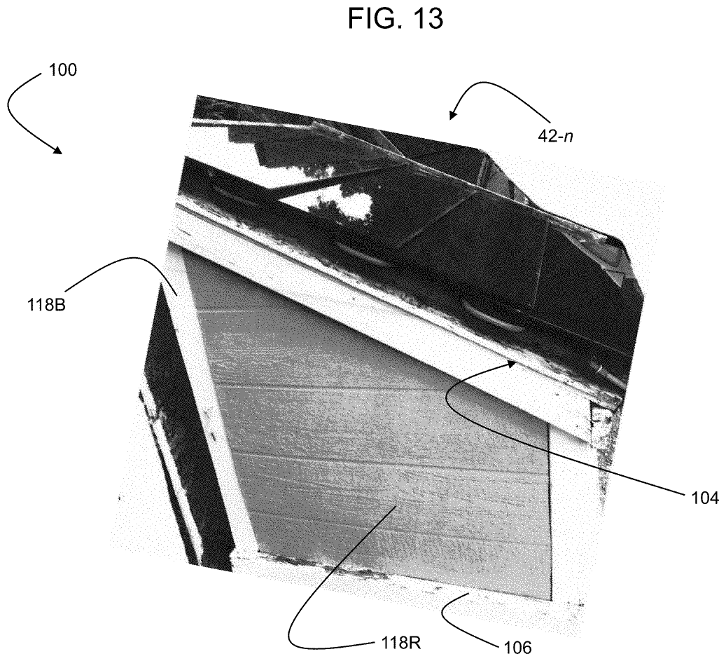

In another exemplary embodiment hereof as shown in FIGS. 11-13, the integrated thermal-electric roofing system 10 may be portable and/or transportable. In one exemplary embodiment, the integrated thermal-electric systems 42 (comprising one or more thermal-electric modules 42-n) may be portable and/or transportable, individually and/or in any combination. In another exemplary embodiment hereof, one or more integrated thermal-electric systems 42 (comprising one or more thermal-electric modules 42-n) may be configured with other systems and/or components (e.g., a pump and thermal control system 200, a liquid storage tank 202, a heat exchanger 204, an inverter 32, a battery 116 and/or other systems and/or components) as described above to form a portable and/or transportable integrated thermal-electric system 100. Note that the one or more thermal-electric systems 42 may need not necessarily be configured with any and/or all of the systems and/or components listed above, and that the scope of the system 10 or of the portable and/or transportable integrated thermal-electric roofing system 100 is not limited in any way by the systems and/or components that the thermal-electric systems 42 may be configured with to form the portable and/or transportable system 100.

In one exemplary embodiment as shown in FIG. 11, one or more integrated thermal-electric modules 42-n, individually or in any combination, may be mounted onto or otherwise configured with a portable and/or transportable structure 102. The structure 102 may include a back plate 104 to which the integrated thermal-electric modules 42-n may be mounted, a base 106 that may provide vertical support to the structure 102, one or more support arms 108, mobility mechanisms 110 (e.g., wheels, rollers, tracks, or other types of mobility mechanism that may allow for the structure 102 may be easily moved) and/or other components as required. It may be preferable that the portable and/or transportable structure 102 include an inner area 114 within which other systems and/or components may be configured, however, this may not be required.

In some exemplary embodiments hereof, other systems and/or components (e.g., a pump and thermal control system 200, a liquid storage tank 202, a heat exchanger 204, an inverter 32, a battery 116 and/or other systems and/or components) may also be configured with the one or more integrated thermal-electric modules 42-n (as described above) and the portable and/or transportable structure 102 to form a portable and/or transportable integrated thermal-electric system 100. In one exemplary implementation, one or more of the other systems and/or components may be housed within the inner area 114 of the portable and/or transportable structure 102 such that the combined unit 100, 102 may be a self-contained turnkey portable and/or transportable integrated thermal-electric system 100, however, it is understood that the other systems and/or components may be housed in other areas.

In one exemplary embodiment hereof, the portable and/or transportable integrated thermal-electric system 100 may include one or more rechargeable batteries 116 that may receive and store the electrical energy produced by the solar roofing modules 27-n, and/or the integrated thermal-electric modules 42-n. In this way, the portable and/or transportable integrated thermal-electric system 100 may store electrical energy into the one or more batteries 116 as desired (e.g., when connection to the grid is not available or is undesirable). It may be preferable that the portable and/or transportable integrated thermal-electric system 100 include power outlets and/or other types of outlets that may allow for electronics to be plugged into the outlets to receive electricity from the batteries 116. In this way, the portable and/or transportable integrated thermal-electric roofing system 100 may be a turnkey, self-contained, standalone portable and/or transportable integrated thermal-electric system 100.

As shown in FIG. 11, the one or more integrated thermal-electric modules 42-n may be mounted on the back plate 104 and configured with one or more of the other systems (e.g., a pump and thermal control system 200, a liquid storage tank 202, a heat exchanger 204, an inverter 32 and/or other systems and/or components) that may be housed in the inner area 114. This may generally form a portable and/or transportable integrated thermal-electric system 100. The mobility mechanisms 110 may include wheels and/or rollers that may be configured with the base 106 of the unit 102 to allow the unit 102 to be rolled or otherwise moved. The support arm 108 may extend upward from the base 106 and may provide vertical support to the back plate 104. It is understood that the architecture of the support structure 102 including the back plate 104, the base 106 and the support arm 108 is meant for demonstration purposes, and that any other architecture that may provide the portable and/or transportable integrated thermal-electric system 100 with adequate support may be used. It is also understood that the scope of the portable and/or transportable integrated thermal-electric system 100 is not limited in any way by the architecture of the support structure 102.

The support structure 102 may also include a pivot point 110 (e.g., a hinge, a rotor, or other type of pivoting mechanism) configured with a lower portion of the back plate 104 that may allow for the back plate 104 to rotate downward in the direction of the arrow A in FIG. 11 when the support arm 108 may be released (may be repositioned so that it no longer provides vertical support to the back plate 104). In this way, the support arm 108 may be repositioned and the back plate 104 may be rotated downward until it may rest at a lower angle (e.g., upon the base 106 fully or at least partially). In this way, the portable and/or transportable integrated thermal-electric roofing system 100 and the support structure 102 may be transformed into a smaller and more compact unit. It may be preferable that the systems and/or components 200, 202, 204, 32 that may be housed in the inner area 114 be moved or configured so that they may not obstruct the movement of the back plate 104.

In one exemplary embodiment hereof as shown in FIGS. 9 and 10, the support structure 102 may include a back plate 104 onto which one or more integrated thermal-electric modules 42-n may be mounted, one or more back support arms 108B, one or more front support arms 108F, a base 106, a front wall 116, a back wall (not seen), a left side wall 118 and a right side wall 118R. The interior of the structure formed by the base 106, the front wall 116, the back wall (not seen), the left side wall 118L and the right side wall 118R, may include the inner area 114 within which the systems and/or components 200, 202, 204, 32 may be housed. This architecture may provide and generally enclosed and safe environment for the systems and components 200, 202, 204, 32 and any other systems and/or components as required.

It will be understood by a person of ordinary skill in the art, upon reading this specification, that the support structure 102 may include any other structural elements as required to fulfill its functionalities and need not necessarily include any and/or all the structural elements described above. It is also understood that the scope of the support structure 102 and/or the portable and/or transportable integrated thermal-electric system 100 is not limited in any way by the types of structural elements that the support structure 102 may include.

The portable and/or transportable integrated thermal-electric system 100 combined with the support structure 102 may be used generate electricity and hot water for use with camping, disaster relief and in other situations where electricity and/or hot water may not be readily available.

In another exemplary implementation, the portable and/or transportable integrated thermal-electric system 100 may be used to desalinate the water that may be heated by the system 100. In this case, the water may be heated by the system 100 to create steam that may be subsequently condensed.

In another exemplary embodiment hereof, two or more portable and/or transportable integrated thermal-electric systems 100 may be configured together to form a larger portable and/or transportable integrated thermal-electric system 100.

Those of ordinary skill in the art will appreciate and understand, upon reading this description, that any and/or all of the aspects described in this specification in relation to any of the embodiments hereof may be combined in any way. It is understood that the system 10 may include any and/or all of the aspects and elements of any of the embodiments described. It is also understood that any embodiments hereof may provide different and/or additional advantages, and that not all embodiments or implementations need have all advantages.

Those of ordinary skill in the art will appreciate and understand, upon reading this description, that any and/or all of the aspects described in this specification in relation to any of the embodiments hereof may be combined in any way. It is understood that the system 10 may include any and/or all of the aspects and elements of any of the embodiments described. It is also understood that any embodiments hereof may provide different and/or additional advantages, and that not all embodiments or implementations need have all advantages.

A person of ordinary skill in the art will understand, that any method described above or below and/or claimed and described as a sequence of steps is not restrictive in the sense of the order of steps.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A thermal-electric system comprising:
a support structure;
at least one thermal collector;
at least one photovoltaic tile;
wherein the at least one thermal collector is configured with the at least one photovoltaic tile to form at least one thermal-electric module; and
wherein the at least one thermal-electric module is configured with the support structure.

2. The system of claim 1 wherein two or more thermal collectors configured are configured with two or more photovoltaic tiles respectively to form two or more thermal-electric modules, and wherein the two or more thermal-electric modules are configured with the support structure.

3. The system of claim 1 wherein the at least one thermal collector includes tubing for circulating liquid that is heated by the sun.

4. The system of claim 3 further comprising a thermal control system that pumps the liquid through the tubing.

5. The system of claim 3 further comprising a heat exchanger that receives heat from the heated liquid.

6. The system of claim 1 wherein the at least one photovoltaic tile absorbs sunlight and converts it to electricity.

7. The system of claim 1 wherein the at least one thermal collector absorbs heat from the at least one photovoltaic tile.

8. A method of heating a liquid and creating electricity, the method comprising:
(A) providing at least one thermal collector;
(B) providing at least one photovoltaic tile; and
(C) combining the at least one thermal collector with the at least one photovoltaic tile to form at least one thermal-electric module;
(D) providing a support structure; and
(E) configuring the at least one thermal-electric module of (C) with the support structure;
wherein the thermal-electric module provides hot liquid and electricity.

11. The method of claim 8 wherein the providing in (A) includes providing two or more thermal collectors; the providing in (B) includes providing two or more photovoltaic tiles; the combining in (C) includes combining the two or more thermal collectors with the two or more photovoltaic tiles to form two or more thermal-electric modules respectively.

12. The method of claim 8 wherein the at least one thermal collector includes tubing for circulating a liquid that is heated by the sun.

13. The method of claim 8 further comprising the step:
(F) using the at least one thermal-electric module to absorb sunlight and convert it to electricity.

14. The method of claim 8 further comprising the step:
(G) providing a heat exchanger;
wherein the heat exchanger receives heat from the hot liquid.

15. A portable thermal-electric system comprising:
a standalone support structure;
at least one thermal collector;
at least one photovoltaic tile;
at least one rechargeable battery;
wherein the at least one thermal collector is configured with the at least one photovoltaic tile to form at least one thermal-electric module; and
wherein the at least one thermal-electric module is configured with the standalone support structure.

16. The system of claim 15 wherein the at least one thermal collector includes tubing for circulating liquid that is heated by the sun.

17. The system of claim 16 further comprising a thermal control system that pumps the liquid through the tubing.

18. The system of claim 16 further comprising a heat exchanger that receives heat from the heated liquid.

19. The system of claim 15 wherein the at least one photovoltaic tile absorbs sunlight and converts it to electricity.

20. The system of claim 15 wherein the at least one thermal collector absorbs heat from the at least one photovoltaic tile.
